(19) United States
(12) Patent Application Publication
(10) Pub. No.: US 2014/0201948 A1
(43) Pub. Date: Jul. 24, 2014

(54) MOVABLE MOUNTING PLATE FOR FURNITURE HINGES

(71) Applicant: Julius Blum GmbH, Hoechst (AT)

(72) Inventor: Fredi DUBACH, Baeretwil (CH)

(73) Assignee: Julius Blum GmbH, Hoechst (AT)

(21) Appl. No.: 14/220,317

(22) Filed: Mar. 20, 2014

Related U.S. Application Data
(63) Continuation of application No. PCT/AT2012/000216, filed on Aug. 23, 2012.

(30) Foreign Application Priority Data
Sep. 21, 2011 (AT) 1359/2011

(51) Int. Cl. E05D 7/00

(52) U.S. Cl. CPC E05D 7/00
USPC 16/354; 16/382

(57) ABSTRACT

The invention relates to a mounting device for fixing a furniture hinge, comprising a base plate, which is to be fixed to a furniture part, in particular a lateral wall of a furniture body, and comprising a fixing device for fixing the hinge to the mounting device, preferably in a removable manner. The fixing device is movably mounted on the base plate, said mounting device having a connecting element which is mounted on the base plate in a movable manner via at least one toggle lever and which can be fixed to a hinge part that can be moved during the opening and closing movement of the hinge, wherein the fixing device can be moved relative to the base plate via the toggle lever.

The invention concerns a mounting device for fixing a furniture hinge including a base plate to be fixed to a furniture part, in particular a side wall of a furniture carcass, and a fixing device for preferably releasably fixing the hinge to the mounting device, wherein the fixing device is mounted moveably on the base plate.

In the pivotal movement of furniture parts connected pivotably relative to each other by means of a hinge from the closed position into the open position there is basically the risk that collisions with adjacent furniture parts can occur. That involves in particular furniture doors which are pivotable by means of the hinge and which serve for closing off a furniture carcass and which can collide with adjacent furniture doors or other projecting furniture parts upon being opened or closed.

To resolve that problem, AT 369 107 discloses an especially constructed wide-angle hinge with which it is possible to achieve a lifting-away movement for pivoting the door from the end edge of the furniture carcass, during the opening movement of the furniture door. In that case fixed to the furniture carcass is a mounting housing having two slots which are disposed one behind the other and in which pins connected to the hinge arm are moveably mounted, whereby the hinge arm is guided displaceably and partially pivotably. In that situation a gear meshing with two toothed racks which are moveable relative to each other serves to drive the hinge arm whereby the latter moves relative to the mounting housing which is fixed to the furniture carcass and a greater opening movement of the furniture door is achieved.

DE 43 18 607 also discloses a wide-angle hinge in which the door is pivoted away from the furniture carcass during the opening movement to avoid collisions with adjacent furniture doors. Once again arranged in a mounting housing fixed to the furniture carcass are a plurality of slots in which pins connected to the hinge arm are displaceably mounted, wherein to drive the hinge arm a pulling means is fixed in the hinge cup, the pulling means being held in a constantly stressed condition.

The above-mentioned hinges suffer from the disadvantage of a complicated structure which is thus susceptible to faults. As such hinges are not necessary for all furniture doors the complication and expenditure involved in the production of that kind of hinges is excessively high.

Another possible way of achieving an increased opening movement is disclosed in WO 2006/053364. The hinge described there has an intermediate portion between the hinge cup and the hinge arm, the intermediate portion being positively coupled to the hinge arm by way of two levers, wherein the levers are rotatably mounted both to the intermediate portion and also to the hinge arm by way of suitable spindles. The intermediate portion which is moveable relative to the hinge arm provides that the furniture door has an increased motion component in a direction out of the furniture carcass.

DE 34 07 174 C2 also discloses a cross-link hinge with an increased opening movement, which is made possible by a two-part hinge arm. A lower part of the hinge arm is fixedly secured to a mounting plate on the furniture carcass. Arranged on the moveably mounted upper part of the hinge arm is a hinge lever having a gear segment meshing with a toothed bar on the lower part. The hinge lever is connected to a hinge arm of the cross-link hinge, thereby permitting motional coupling of the hinge arm and the upper part. Besides the disadvantage that the increased opening stroke movement is made possible only for cross-link hinges the hinge arm has to be connected to the base plate in a complicated structure with a complex fixing device, thereby involving a particularly high level of assembly complication and expenditure. In addition that device has the disadvantage that further moveably mounted small parts are added to the parts which are already present in the hinge and which are moveable relative to each other, thereby increasing the complexity and susceptibility to defect of the hinge.

The disadvantage of these types of hinge is that they are in turn designed only for a specific purpose of use, thereby giving a high level of complication and expenditure both for the hinge manufacturer and also for the assembly fitter who must always have all possible types of hinge available to him.

However, a device which is independent of the hinge and with which the problem of collisions can be resolved in the case of an excessively small opening movement is desirable, in which respect the device can be used with a large number of the commercially available hinges.

On the other hand the extent of the increase in the opening movement, that is linked to that hinge, may still be too slight for many uses. For that situation it would be necessary to provide a device which permits an additional increase in the opening movement.

Therefore the object of the invention is to provide such a device with which the above disadvantages are avoided and which provides a solution to the collision problems in the case of furniture parts which are pivotable by means of hinges, as independently of the hinge itself as possible.

A mounting device to which furniture hinges are fixed serves to attain that object. The mounting device itself has a base plate which is to be fixed to a furniture part for example by means of screws or other fixing means. In particular the base plate is to be fixed to a side wall of a furniture carcass, in which case the furniture hinge serves for opening and closing of a furniture door.

The mounting device further includes a fixing device, by way of which the hinge is fixed to the mounting device. Preferably there is provided here a releasable fixing of the hinge, thereby permitting simple fitment and removal of the hinge when the mounting device is already fixed in place. The hinge is fixed with a fitment portion to the mounting device. That fitment portion can be for example the hinge arm of the hinge.

The fixing device itself is mounted moveably to the base plate whereby a hinge fixed to the fixing device is also mounted moveably to the base plate.

The mounting device further includes a connecting element mounted moveably to the base plate, wherein that connecting element is moveable by way of at least one hinge lever. Besides the fixing device the connecting element also serves for connecting the hinge to the mounting device. For that purpose the connecting element can be fixed to a part which is moveable in the opening and closing movement of the hinge. By virtue of the fact that, in the condition of being connected to the hinge, the connecting element is fixed to a part of the hinge, that is moved in the opening and closing movement of the hinge, and also moves during that movement with the moveable part of the hinge, the movements of the connecting element and the moveable part of the hinge to which the connecting element can be fixed are coupled.

Insofar as it is now provided that the fixing device is moveable relative to the base plate by way of the hinge lever, by way of which the connecting element is mounted moveably to the base plate, the movement of the connecting element, that is coupled to the movement of the hinge, can be transmitted to the fixing device. The extent and the direction of the movement of the fixing device are dependent on the movement of the connecting element which controls the movement of the fixing device.

In the mounted condition of the hinge the hinge is moved by the mobility of the fixing device together with the fixing device relative to the base plate, the movement being guided and controlled by the connecting element. If accordingly during the opening stroke movement of the fitted hinge the part moveable on the hinge moves outwardly in the furniture carcass, the coupling effect means that the fixing device and therewith the hinge fixed to the fixing device are also moved outwardly whereby the opening stroke movement of the hinge is increased. In that case the at least one hinge lever affords a structurally simple method of coupling and guiding the movement, without complicated pulling means with are susceptible to defects or pin arrangements which are guided in slots.

Because the mounting device and the hinge to be fixed to the mounting device are separate components the increased opening stroke movement is achieved independently of the hinge, by the mounting device. If a hinge is used which itself already has an increased opening stroke movement, those increases in the opening movements are added together and provide overall an even greater opening movement. The mounting device according to the invention however can also be used in relation to commercially usual hinges without an increased opening movement, whereby the increase in the opening stroke movement is effected by the mounting device and independently of the hinge itself.

Insofar as that increase in the opening stroke movement is to be attributed to the mobility of the fixing device relative to the base plate, large parts of commercially usual hinges can be connected to such a fixing device insofar as the latter is designed for fixing such hinges. Depending on the respectively prevailing factors in respect of the furniture parts to be pivoted, the mounting fitter can then decide whether he uses a commercially usual non-moveable mounting device or a mounting device according to the invention with the moveable fixing device. It is possible however in both cases to use the same type of hinge, whereby both the manufacturing complication and expenditure and also the mounting complication and expenditure are reduced.

Further advantageous configurations of the invention are defined in the appendant claims.

In a preferred embodiment of the invention it is provided that the connecting element can be fixed to an outside, preferably to the top side, of the moveable part of the hinge. That permits particularly simple mounting and a lever arm which is as large as possible for the hinge lever, by way of which the connecting element is moveable. After the hinge is fitted on the fixing device, for example with the hinge arm, the connecting element is connected to the outside of the moveable hinge part, whereby coupling between the connecting element and the fixing device is implemented in a simple manner by way of the hinge lever. In general the fixing device is arranged at the underside of the hinge so that the lever arm of the hinge lever amounts to the spacing between the top side of the moveable part of the hinge and the underside of the hinge if the connecting lever is fixed to the top side of the moveable part of the hinge, as is preferred.

In an embodiment of the invention the fixing device which is moveable relative to the base plate by way of the hinge lever is moved relative to the base plate with a linear component when the hinge is opened or closed in the mounted condition. By virtue of a linear component the fixing device can be moved outwardly for example in a furniture carcass, during the opening movement of the furniture door, with a linear motion component whereby the spacing of the furniture door relative to the closing edge of the furniture carcass is increased. In the reversed closing movement that spacing is reduced by a linear movement of the fixing device into the interior of the furniture carcass.

In a preferred embodiment of the invention the hinge arm can be clipped on to the fixing device. For that purpose the fixing device has latching elements which are known in the state of the art and which can engage into holding elements or arresting elements corresponding thereto on the hinge arm, thereby affording a snap-action connection. A hinge which can be clipped on permits particularly simple fixing of the hinge to the mounting device. The latching or arresting elements can be resilient or spring-loaded. Preferably disposed in the hinge is a release device with which the snap-action connection can be released again so that the hinge can be easily removed from the mounting device. A release button with which the connection to a latching element can be released serves for example as the release device. For that purpose the arresting element can be partially rotated about an axis with the release button. Releasable snap-action connections of that kind for fixing hinges to mounting plates are known in the state of the art.

In an embodiment of the invention the connecting element can be clipped to the moveable part of the hinge. For that purpose the hinge or the connecting element has latching elements which engage into arresting elements corresponding thereto on the respective other part and permit those parts to be connected. Once again the latching elements and/or the arresting elements can be resilient or spring-loaded and there can be a release device. It can however also be provided that the connecting element is screwed to the moveable part of the hinge or fixed in some other fashion.

In an embodiment of the invention the connecting element has a plate-shaped or a profile-shaped part or is at least in part of a plate-shaped or profile-shaped configuration to bear against the moveable part of the hinge in areal relationship. The profile-shaped part can at least partially embrace the moveable part of the hinge. That permits an efficient and simple way of fixing the connecting element. At the same time the hinge movement can be transmitted uniformly to the connecting element.

In a further embodiment the fixing device is substantially plate-shaped. Deviations from the plate shape are afforded for example by mounting lugs for moveably mounting the hinge lever, by way of which the connecting element is coupled to the fixing device, or the latching or arresting elements for fixing the hinge. The fixing device however can also have a receiving plate to which a fitment portion of the hinge can be fixed. The receiving plate can also be part of the fixing device which is of a substantially plate-shaped configuration. In the case of fixing the hinge arm the receiving plate is preferably of an elongate shape adapted to the shape of the hinge arm.

In a preferred embodiment of the invention the connecting element is in the form of a lever. Preferably in that respect there is provided a two-part lever, thereby affording desirable kinematic relationships in conjunction with the hinge lever, by way of which the connecting element is connected to the fixing device.

In an embodiment the fixing device is hingedly connected to the at least one hinge lever. For that purpose there can be a mounting lug for the at least one hinge lever, with the hinge lever being mounted rotatably to the mounting lug. The connecting element is mounted pivotably relative to the fixing device by way of the hinge lever.

For moveably mounting the hinge lever to the base plate there can also be a mounting lug to which the hinge lever is rotatably mounted.

A further method of moveably mounting the at least one hinge lever to the base plate involves a gear or a gear segment, by means of which the hinge lever is mounted rotatably to the base plate. In that case the hinge lever is mounted both rotationally and also moveably with a translatory movement by way of the gear or the gear segment.

As a counterpart to the gear or gear segment arranged on the base plate is at least one toothed bar with which the gear or the gear segment meshes and which also serves for moveably mounting the hinge lever to the base plate.

At least one further hinge lever can be provided for moveably mounting the fixing device to the base plate. Additionally or alternatively a guide device can be arranged on the base plate, by means of which the movement of the fixing device is guided relative to the base plate.

For hinges in which the hinge arm is moved during the opening and closing movement in the mounted condition of the hinge, the mounting device can be of such a configuration that the connecting element can be fixed to the hinge arm.

In addition, hinges are known in the state of the art, in which there is an intermediate portion which is mounted moveably on the hinge arm and which is preferably coupled to the hinge arm by way of at least two levers. In the mounted condition of the hinge that intermediate portion is moved relative to the hinge arm which is fixedly joined to the furniture carcass. In that case the mounting device is of such a design that the connecting element can be connected to that intermediate portion which represents the moveable part of the hinge.

For that purpose the dimensions of the at least one hinge lever and the connecting element are adapted to the dimensions of the hinge arm or to the dimensions and the arrangement of the intermediate portion mounted moveably to the hinge arm.

The invention also concerns an arrangement having a hinge, in particular a wide-angle hinge, and a mounting device as described above.

In an embodiment the hinge has a hinge arm fixable to the fixing device. In addition there can be an intermediate portion which is mounted to the hinge arm and which is preferably coupled to the hinge arm by way of at least two levers. In that case the connecting element can be fixed to the intermediate portion.

The invention further concerns an article of furniture comprising a furniture carcass and a furniture door mounted moveably to the furniture carcass, wherein a mounting device as described above is mounted to the furniture carcass, a hinge, preferably a wide-angle hinge, for opening and closing the furniture door, being fixed to the mounting device.

Further details and advantages of the present invention are described more fully hereinafter by means of the specific description with reference to the drawings in which:

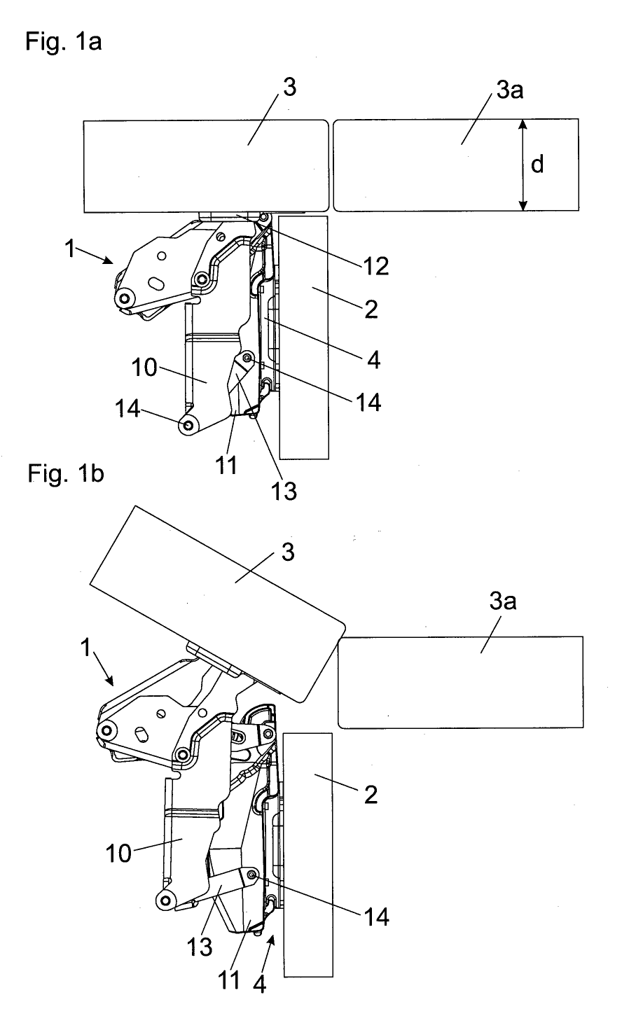

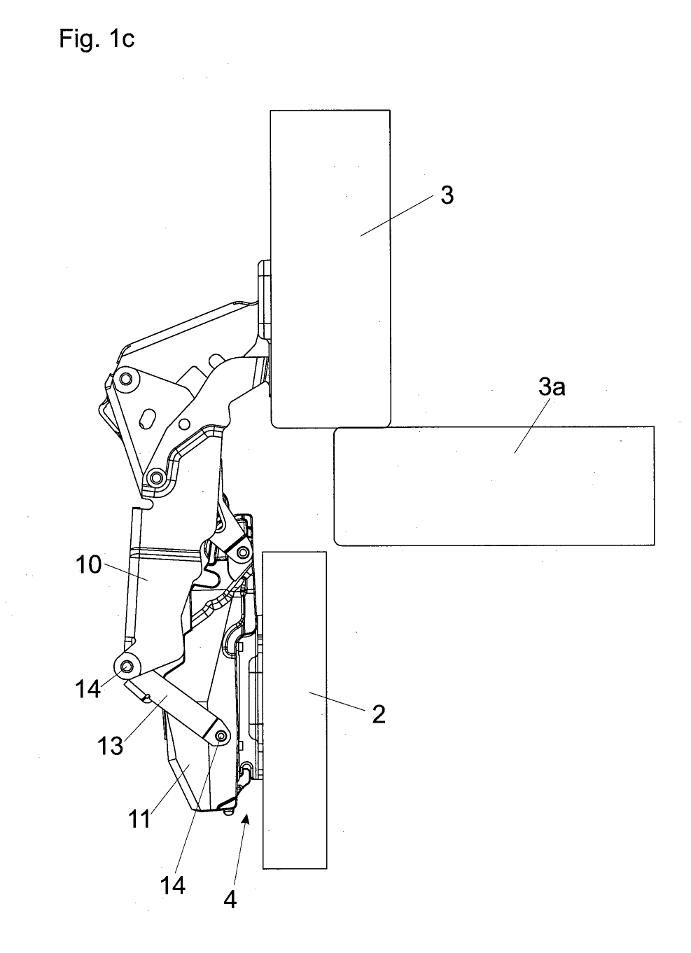

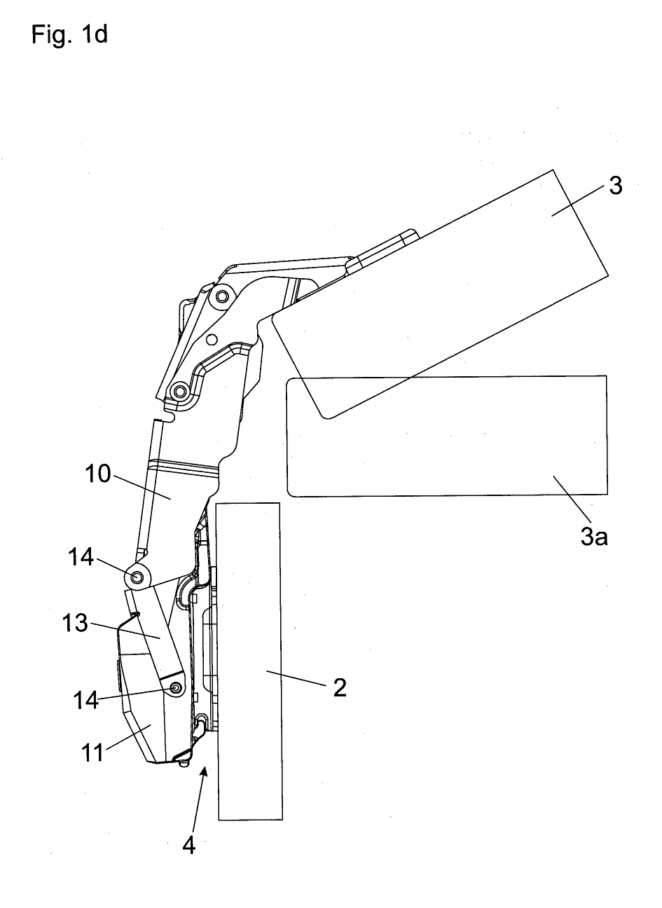

FIGS. 1a through 1d show plan views of a mounting device known in the state of the art with a fixed hinge in various open positions,

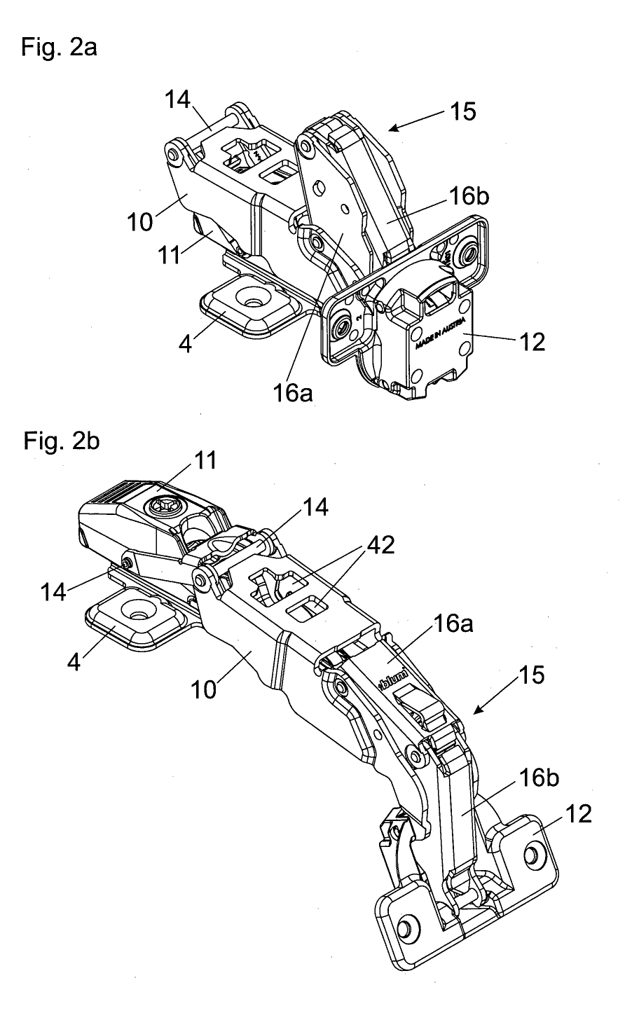

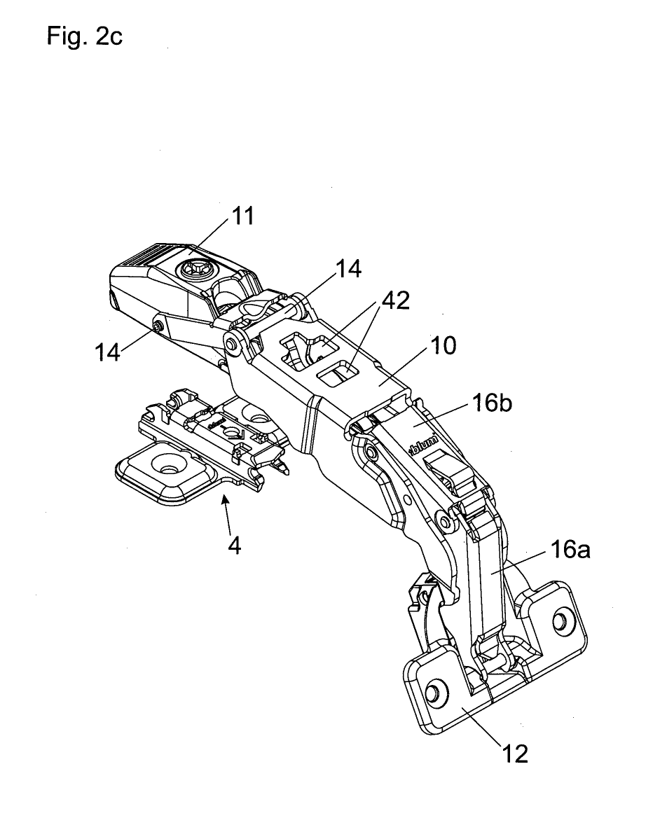

FIGS. 2a through 2c show perspective views of a hinge fixed to a mounting device according to the state of the art in two different open positions and a separate view of those components,

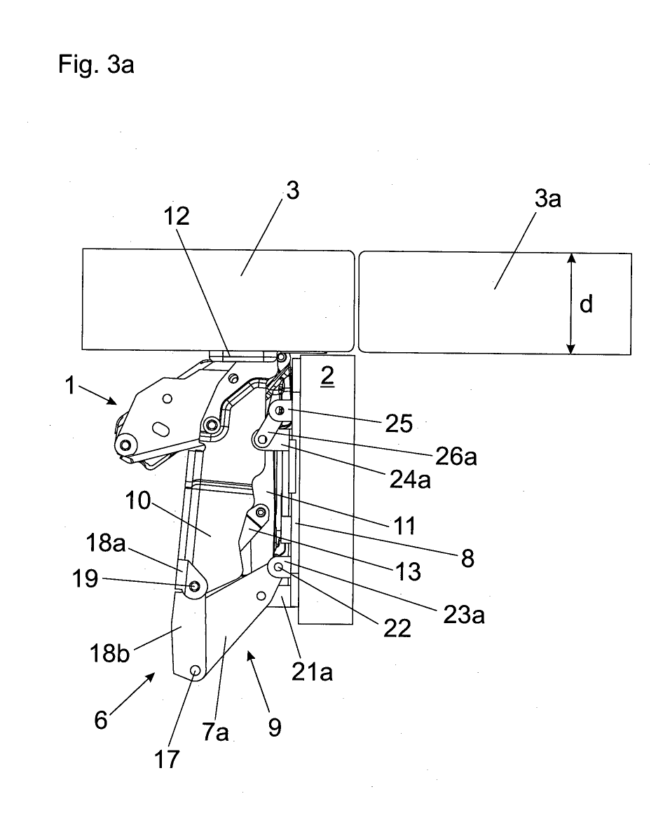

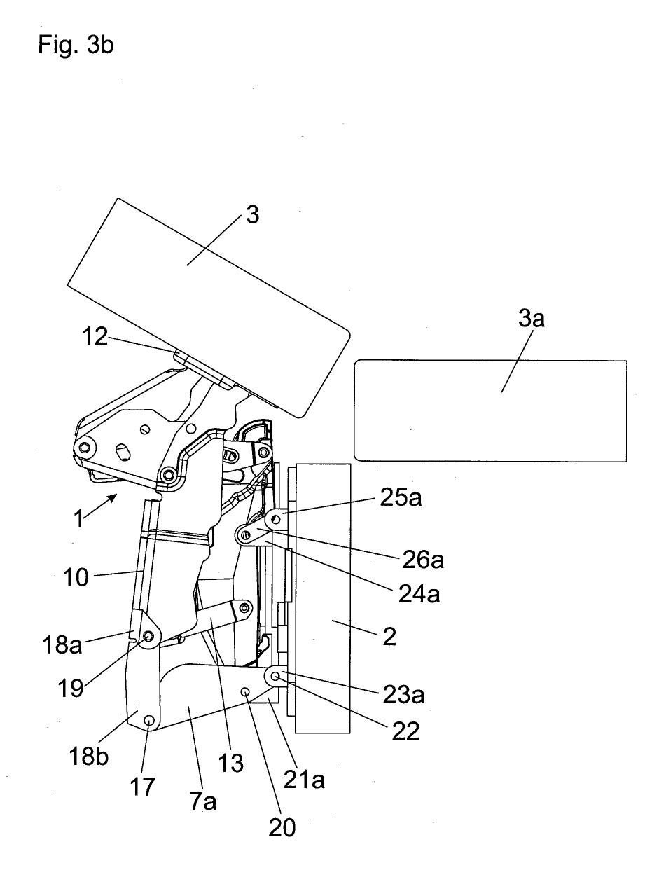

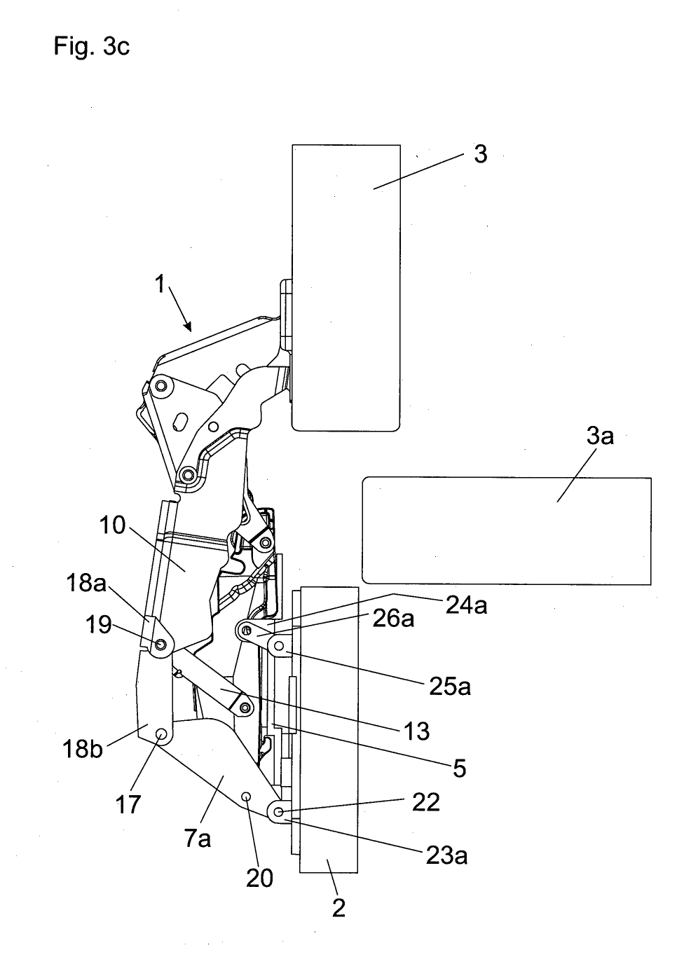

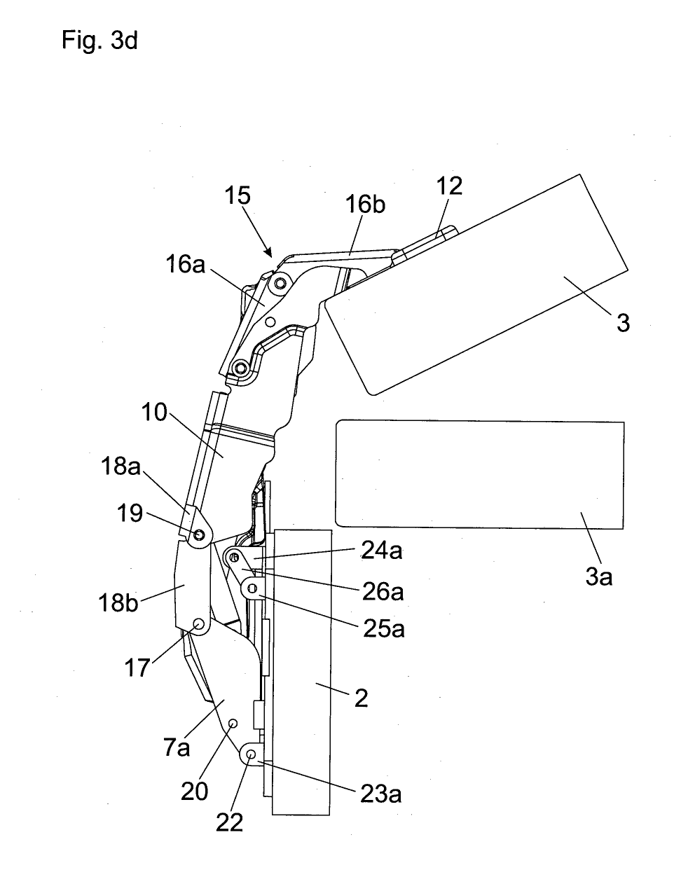

FIGS. 3a through 3d show plan views of a first embodiment of the mounting device according to the invention with fixed wide-angle hinge in various open positions,

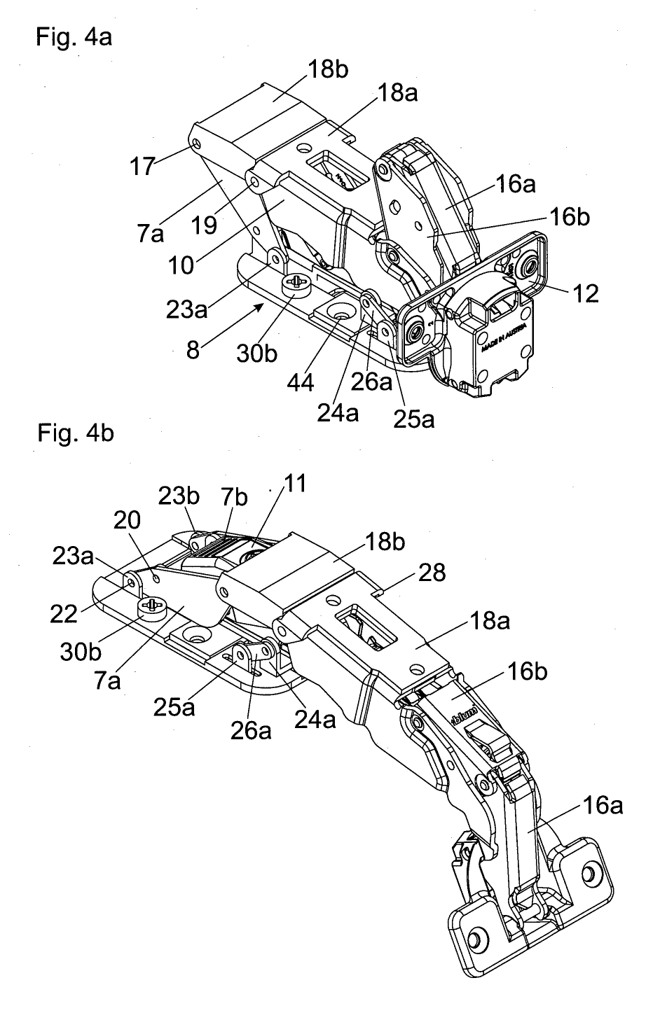

FIGS. 4a and 4b show perspective views of the first embodiment of the mounting device according to the invention with fixed wide-angle hinge in various open positions,

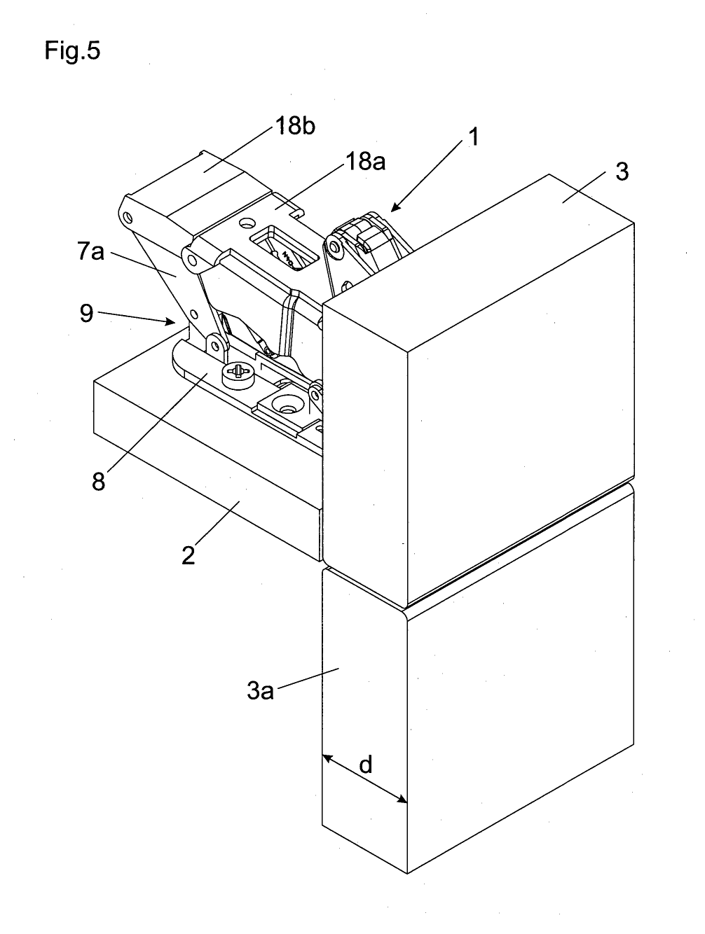

FIG. 5 shows a mounting device of the first embodiment, mounted to a furniture carcass, with fixed wide-angle hinge and furniture door fixed thereto in the closed position,

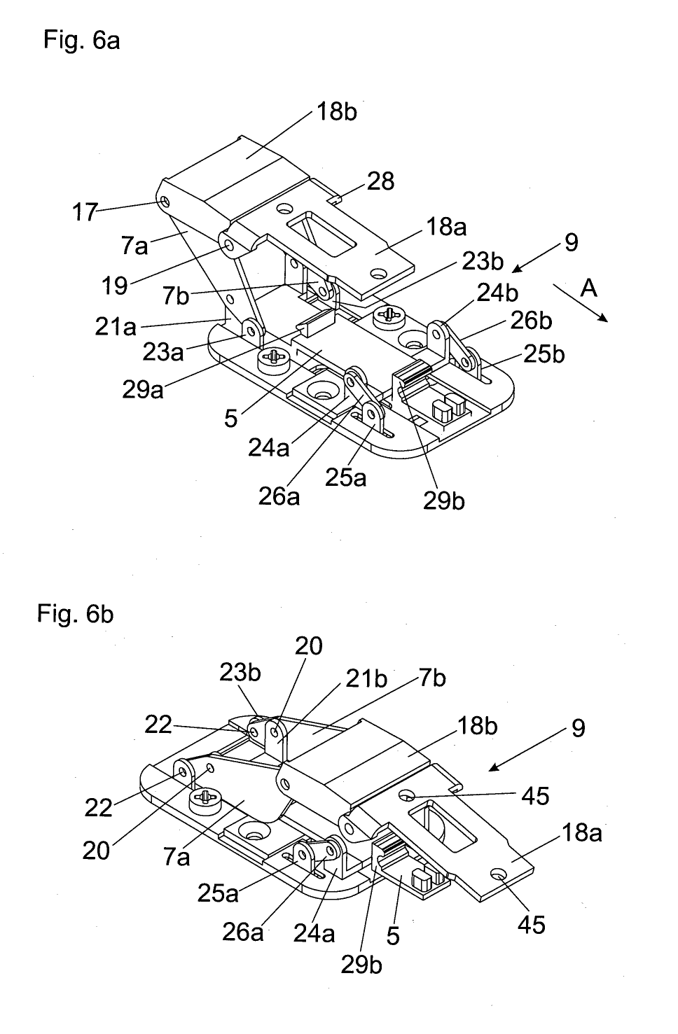

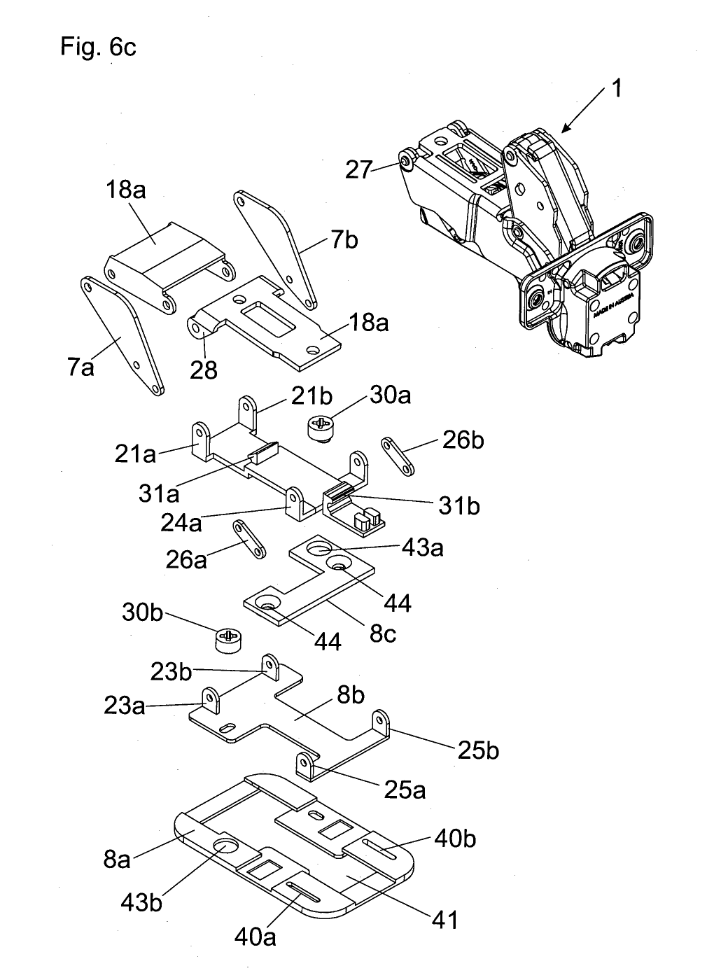

FIGS. 6a through 6c show perspective views of the first embodiment of the mounting device according to the invention in various operating positions and a related exploded view,

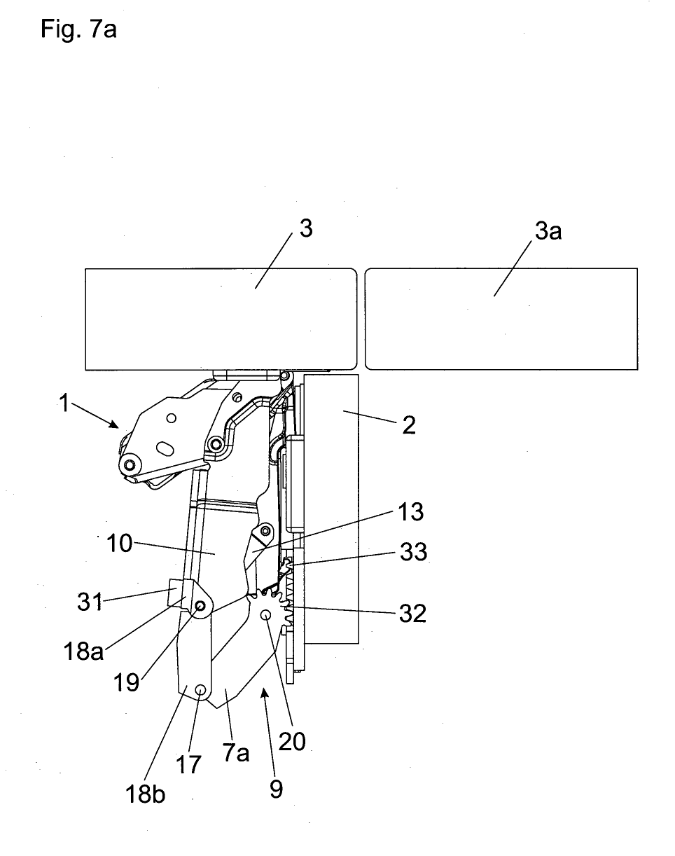

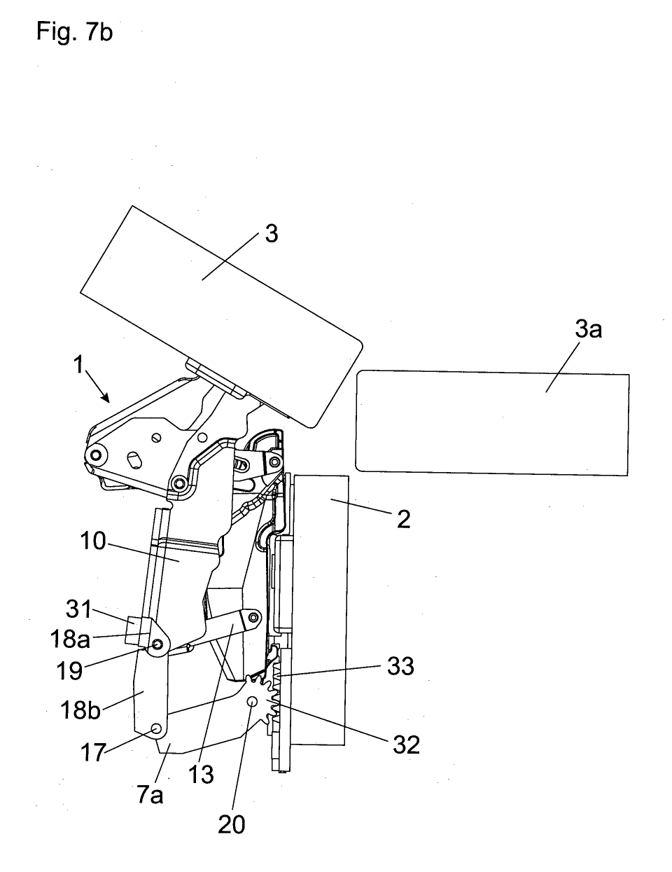

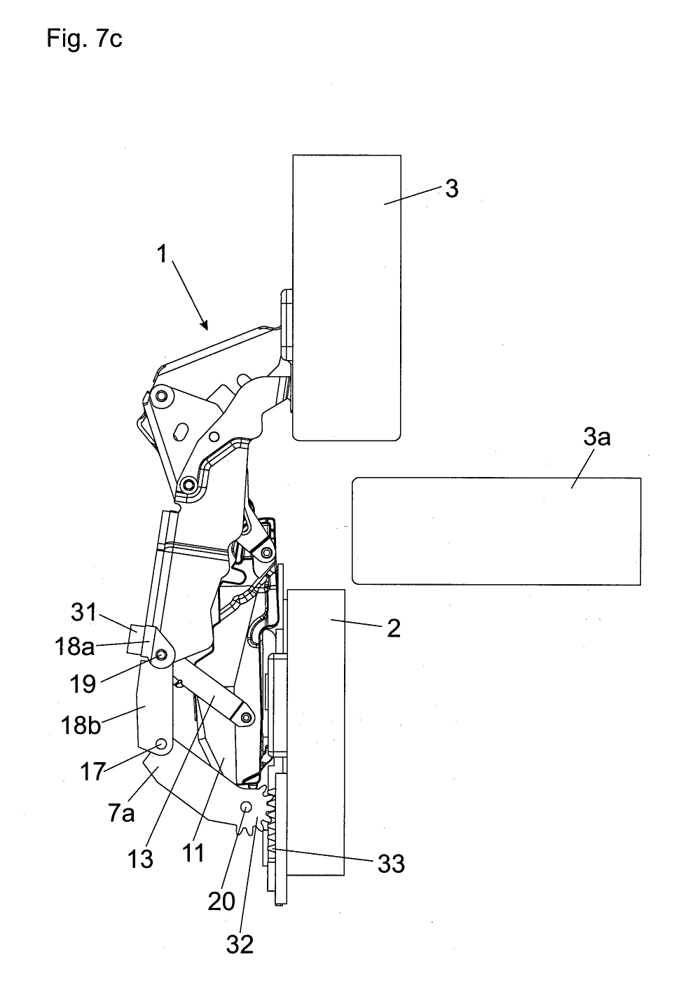

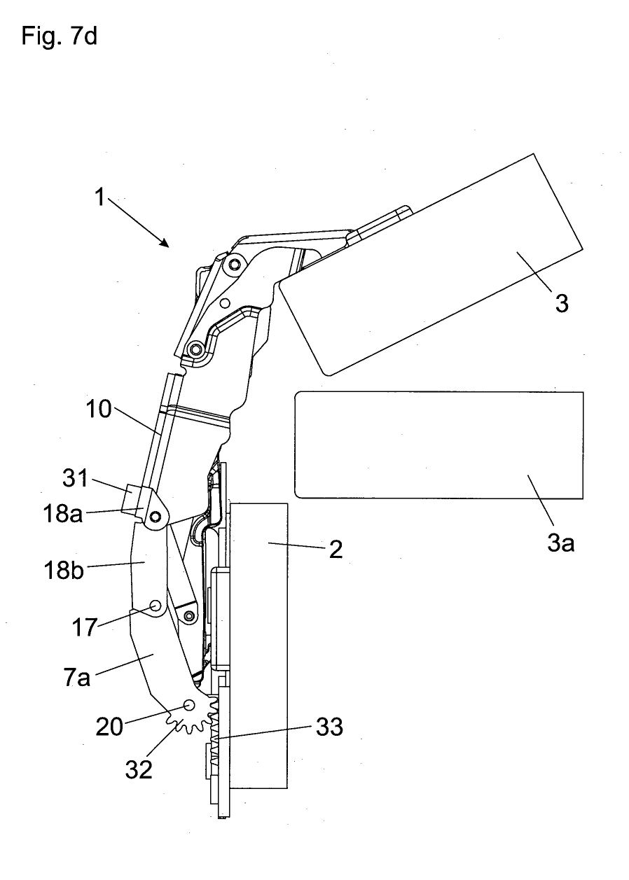

FIGS. 7a through 7d show plan views of a second embodiment of the mounting device according to the invention with fixed wide-angle hinge in various open positions,

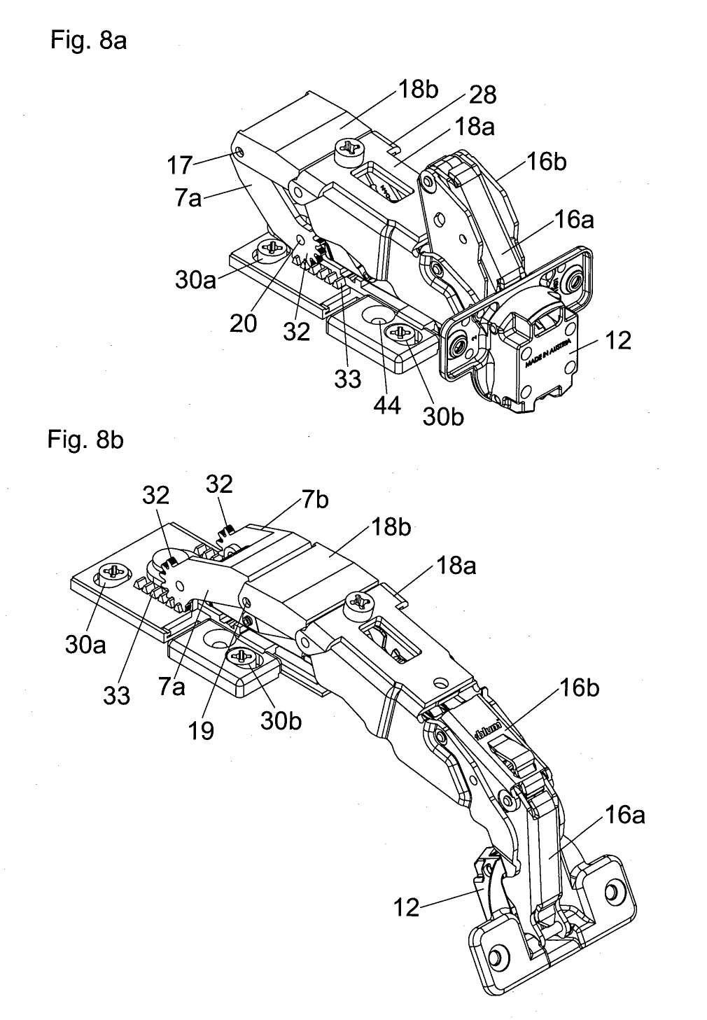

FIGS. 8a and 8b show perspective views of a second embodiment of the mounting device according to the invention with fixed wide-angle hinge in various open positions,

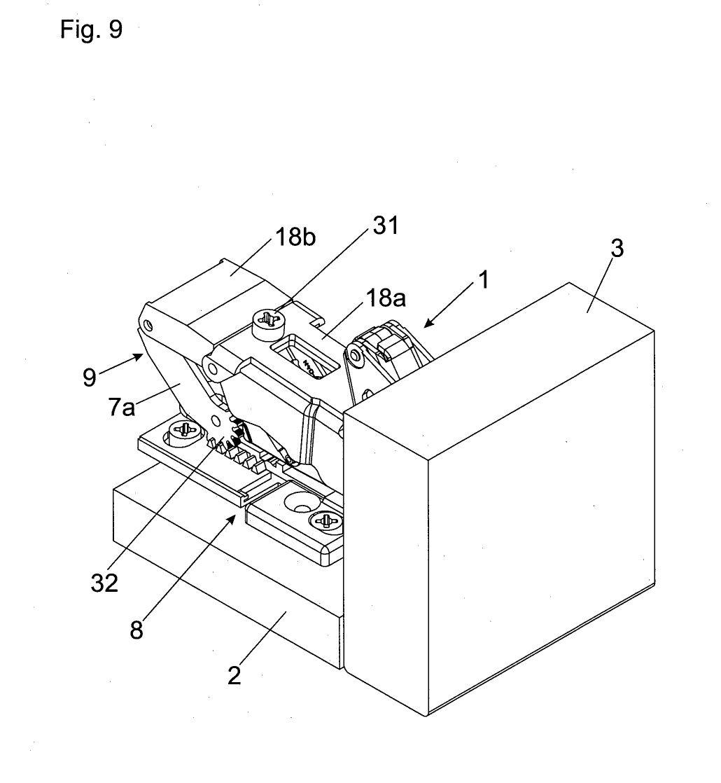

FIG. 9 shows a mounting device of the second embodiment, mounted to a furniture carcass, with fixed wide-angle hinge and furniture door fixed thereto in the closed position, and

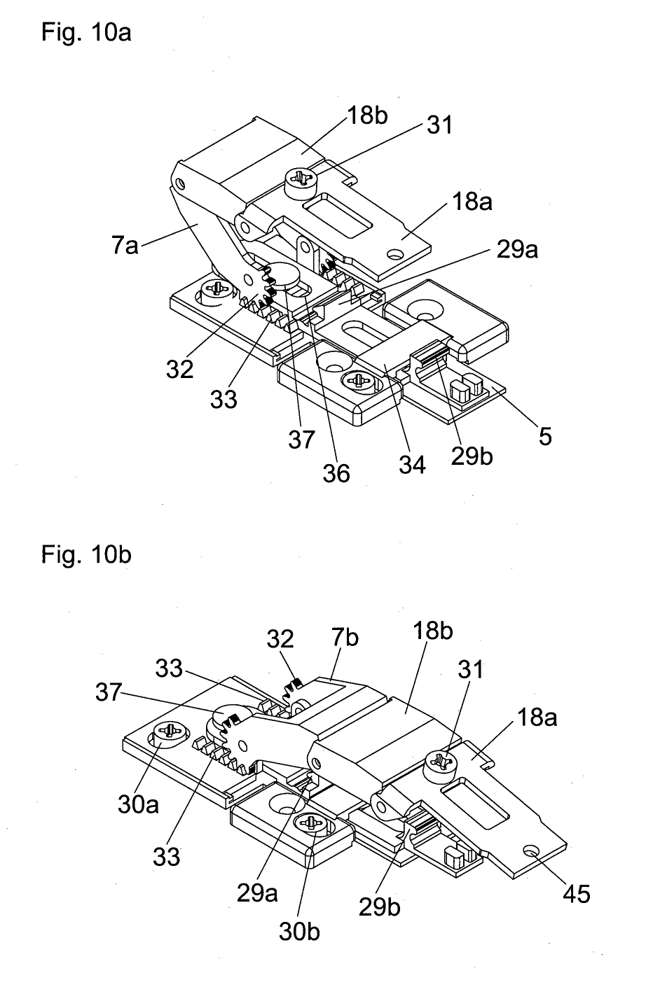

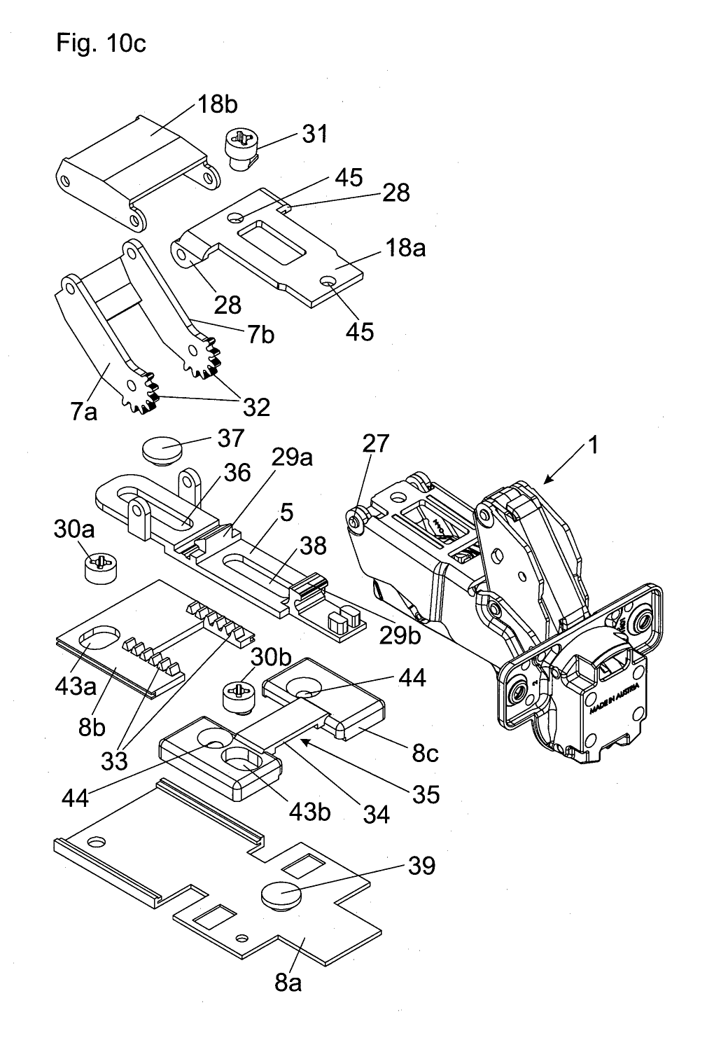

FIGS. 10a through 10c show perspective views of the second embodiment of the mounting device according to the invention in various operating positions and a related exploded view.

FIG. 1a shows a plan view of a mounting plate 4 in the state of the art, mounted to a side wall 2 of a furniture carcass. Fixed to the mounting plate 4 is a wide-angle hinge 1, by means of which a furniture door 3 can be opened and closed. Like the adjacent furniture door 3a the furniture door 3 is of a great thickness d. The hinge 1 is in the end position defined by the closed condition.

In this case the wide-angle hinge 1 is fixed to the mounting plate 4 with a first fitment portion—here the hinge arm 11. With the second fitment portion—here the hinge cup 12—the hinge is fixed to two pivotably mounted furniture doors 3, relative to the side wall.

The intermediate portion 10 is moveable relative to the hinge arm 11 by way of two levers 13 and is positively coupled to the hinge arm by way of the levers 13, wherein the levers 13 are mounted rotatably both on the intermediate portion 10 and also on the hinge arm by way of suitable spindles 14. By means of that intermediate portion 10 it is possible for the furniture parts 2 and 3 not only to be pivoted relative to each other but also for their spacing from each other to be increased in the pivotal movement, that is to say to afford an increased opening stroke movement. For that purpose the intermediate portion 10 is pivoted by means of the levers 13 at the first end position shown in FIG. 1a beyond the hinge arm 11 and prolongs same to the end position shown in FIG. 1d, defined by the completely open position. That means that the two fitment portions 11 and 12 are moved away from each other to differing degrees in the two end positions. A hinge very similar to that hinge 1, with the same functional principle, is disclosed in WO 2006/053364.

As can be seen from FIGS. 1b and 1d the thickness d however is so great that, in spite of the increased opening stroke movement of the hinge 1, a collision occurs between the adjacent furniture doors 3 and 3a. If there were a wish to even further increase the opening stroke movement the proportions of the hinge would have to be markedly increased, whereby valuable space inside the furniture carcass is lost.

FIGS. 1a, 1b, 1c and 1d represent the time sequence of the opening movement of the hinge 1 with fixed furniture door 3. As a consequence of the collision diagrammatically shown in FIG. 1d between the furniture doors 3 and 3a the theoretically possible maximum opening angle of about 170° of the hinge 1 cannot be reached.

FIG. 2a shows a perspective view of the hinge 1 in the condition of being connected to the mounting plate 4 of the state of the art. The hinge 1 is in the closed position. The limbs 16a and 16b of the hinge lever 15 of the hinge are in the completely folded-together condition.

FIG. 2b shows a perspective view of the hinge 1 in the second end position in which the hinge 1 is completely open. The limbs 16a and 16b of the hinge lever 15 are completely pivoted away from each other. The intermediate portion 10 is also in the end position defined by the hinge lever 13, relative to the hinge arm 11, whereby the maximum opening stroke movement is achieved.

FIG. 2c shows the view of FIG. 2b with the mounting plate 4 of the state of the art, separate from the hinge. In this case the mounting plate 4 is of such a design configuration that the hinge arm 11 can be easily clipped on to the mounting plate 4, thereby providing a snap-action connection. The mounting plate 4 itself is fixed to the furniture carcass with screws.

FIG. 3a shows a plan view of a hinge 1 which substantially corresponds to the hinge 1 in FIGS. 1 and 2. The hinge 1 is again fixed with a hinge cup 12 to a furniture door 3 and to a side wall 2 of a furniture carcass by way of a hinge arm 11. In this case the hinge arm 11 is again not fixed directly to the furniture carcass, but by way of a mounting device 9 according to the invention.

The hinge 1 itself has the increased opening stroke movement already described hereinbefore, which in regard to the prevailing factors, by virtue of the thickness d of the furniture doors 3, 3a, is not sufficient to avoid collisions during the opening movement. A connecting element 6 is fixed to the intermediate portion 10 mounted moveably relative to the hinge arm 11 by way of the hinge lever 13, which connecting element 6 in this embodiment is in the form of two-part lever comprising the lever arms 18a and 18b which are connected rotatably relative to each other by way of the spindle 19. The hinge levers 7a, 7b are rotatably connected to the connecting element 6 by way of the spindle 17. The hinge levers 7a and 7b are further mounted rotatably to the fixing device 5 by way of the spindle 20. Mounting lugs 21a, 21b arranged on the fixing device 5 serve for that purpose.

In addition the hinge levers 7a, 7b are mounted rotatably to the base plate 8 by way of the spindle 22. Mounting lugs 23a, 23b are also arranged on the base plate 8 for that purpose. Also arranged on the fixing device 5 are further mounting lugs 24a, 24b, to which a respective further hinge lever 26a, 26b is mounted. The further hinge levers 26a, 26b are rotatably mounted at their other end to the base plate 8, further mounting lugs 25a, 25b being provided for that purpose on the base plate 8.

FIGS. 3a, 3b, 3c and 3d correspond to the time sequence of an opening movement of the hinge 1. As can be seen in particular from FIGS. 3b and 3d the opening stroke movement which is already increased by the hinge is further increased by the mounting device 9 so that no collision between the adjacent furniture doors 3 and 3a occurs and the hinge 1 can be opened to its maximum opening angle, that is to say to its end position. The movement of the fixing device 5 relative to the base plate 8 can be particularly clearly seen by virtue of the movement of the mounting lugs 24a, 24b on the fixing device 5, relative to the mounting lugs 25a, 25b on the base plate 8.

FIG. 4a shows the hinge 1 in the condition connected to the first embodiment of the mounting device 9 according to the invention, in its closed position. The connecting element 6 is in the form of a two-part lever comprising lever arms 18a and 18b. The lever arm 18a of the connecting element 6 is partially of a plate-shaped configuration and in the condition of being connected to the hinge 1 bears flat against the top side of the intermediate portion 10. The connecting element 6 has latching elements which are not visible in this Figure and which are in engagement with corresponding arresting or holding elements of the hinge 1 for fixing the connecting element 1. In that respect one of the or both openings 42 shown in FIGS. 2b and 2c in the intermediate portion 10 can serve as the arresting elements, which openings 42 are in latching engagement with latching elements which are arranged on the connecting element 6 and which can be of a resilient nature or spring-loaded, and they can thus form a snap-action connection. Alternatively however it is also possible to provide for fixing with a screw or screws which can be fitted into holes 45 in the connecting element 6.

In addition thereto the lever arm 18a has two tongues 28 which are hingedly connected to the second lever arm 18b and the hinge 1 by way of the spindle 19. In that arrangement the tongues 28 can be clipped on to slightly projecting pin portions 27 of the hinge 1, thereby providing a simple and releasable snap-action connection.

FIG. 4b shows the hinge 1 with mounting device 9 in the completely open position, utilizing the entire opening stroke movement of the hinge 1 and the mounting device 9.

FIG. 5 shows a perspective view of the first embodiment of the mounting device 9, fixed to a side wall 2 of the furniture carcass. The hinge 1 which is in the closed position is connected to the side wall 2 by way of the mounting device 9 and to the furniture door 3a by way of the hinge cup 12.

FIGS. 6a and 6b show the mounting device 9 without hinge 1 in the closed position (FIG. 6a) and in the open position (FIG. 6b). It can be seen that the fixing device 5 with the further hinge levers 26a, 26b forms a parallel lever assembly. The connecting element 6 can be fixed to the intermediate portion 10 which moves during the opening and closing movement of the hinge 1. The fixing device 5 is operated by way of the hinge levers 7a, 7b, in which case the fixing device 5 is moved relative to the base plate 8 by the movement of the connecting element 6, that is coupled to the hinge movement, during the opening and closing process of the hinge 1. In the opening movement the fixing device 5 moves in the direction of the arrow A relative to the base plate 8. The connecting element 6 is fixed to the hinge 1 by means of latching elements which are known in the state of the art and which are not visibly illustrated in FIGS. 6a through 6c, whereby the connecting element 6 can be clipped on to the intermediate portion 10.

The hinge arm 11 of the hinge 1 is clipped on to the fixing device 4, resilient latching elements 29a, 29b being provided for that purpose and engaging into corresponding arresting elements of the hinge arm. The hinge itself has a release device, by means of which the connection to the mounting device 9 can be released again.

When the furniture door 3 is opened, the fixing device 5 moves together with the hinge 1 and the furniture door 3a fixed thereto in an arc out of the furniture carcass and passes around the adjacent door 3a. That combination of stroke movement and linear movement can be particularly clearly seen in FIGS. 3b through 3d. In the end position shown in FIG. 6b the mounting lugs 24a, 24b arranged on the fixing device 5 have been moved forwardly relative to the mounting lugs 25a, 25b on the base plate 8, in relation to the end position shown in FIG. 6a.

FIG. 6c shows an exploded view of the mounting device 9 and a perspective view of the hinge 1 to be fixed thereto. The base plate 8 comprises three plate-shaped elements 8a, 8b, 8c and is fixed to the furniture carcass with screws (not shown) which are fitted into holes 44 provided for same. The part 8b is fitted into openings 41 provided for same in the part 8a so that the base plate 8 is of a compact structural height. The part 8c is fitted under a bridge-shaped part of the fixing device 5. Relative mobility of the fixing device 5 is limited by the leg of the part 8c. The mounting lugs 25a, 25b are fitted into slot-shaped openings 40a, 40b in the base plate element 8a.

The base plate 8 has adjusting means for adjustment in respect of height and depth. Eccentrics 30a and 30b which are fitted into openings 43a and 43b respectively serve that purpose.

FIGS. 7a through 7d show plan views of a time sequence of the opening movement of a hinge 1 fixed to a second embodiment of the mounting device 9 according to the invention. It is possible once again to see the opening stroke movement which is increased in relation to the hinge 1, whereby collisions with the adjacent furniture door 3a can be avoided. In this embodiment the connecting element 6 is fixed to the intermediate portion 10 with a screw 31 fitted into one of the openings 45. The hinge levers 7a and 7b are again mounted rotatably to mounting lugs 21a, 21b of the fixing device 5 by way of a spindle 20.

In this embodiment of the mounting device the hinge levers 7a, 7b are however not connected to the base plate 8 by way of a fixed joint but at their ends have a respective gear segment 32 meshing with a corresponding toothed bar 33 of the base plate 8. Consequently the hinge levers 7a, 7b are not only rotated but also displaced with a translatory movement during the movement of the hinge 1 relative to the base plate, as can be clearly seen on the basis of the shift in position of the gear segment 32 relative to the toothed bar 33 in FIG. 7a through 7d.

FIG. 8a shows the hinge 1 and the connected mounting device 9 in the closed position of the hinge 1. The gear segments 32 of the hinge levers 7a, 7b are arranged at the end of the toothed bars 33, that is at the inside of the carcass.

FIG. 8b shows the completely open position of the hinge 1 and of the mounting device 9. Now the gear segment 32 is arranged at the end of the toothed bar 33, that is at the outside of the carcass, this corresponding to the maximum mobility of the fixing device 5 relative to the base plate 8.

FIG. 9 shows the hinge 1 and the mounting device 9 of FIG. 8a, wherein the mounting device 9 is mounted to the side wall 2 of the furniture carcass and the hinge 1 is mounted with the hinge cup to the furniture door 3.

FIG. 10a shows a perspective view of the second embodiment of the mounting device 9. A part 8c of the base plate 8 has a bridge-like connection 34 over an opening 35, which serve as a guide device for the fixing device 5. Instead of the parallel lever assembly of the first embodiment the hinge lever 7a which is controlled by the gear segment has the advantage that the fixing device 5 is only moved linearly relative to the base plate 8 and does not require any additional stroke movement, as can also be seen from FIGS. 7a through 7d.

FIG. 10b shows a perspective view of the mounting device 9 in the completely open position, thereby affording the maximum additional opening stroke movement in relation to the opening stroke movement by the hinge 1.

It can be seen from an exploded view of the mounting device 9 and a perspective view of the hinge 1 in FIG. 10c that the base plate 8 is again composed of three parts 8a, 8b, 8c. Adjustment in respect of height and depth of the base plate 8 fixed to the furniture carcass is possible by means of eccentrics 30a and 30b and the openings 43a and 43b. While in the first embodiment the further hinge levers 26a, 26b prevented the fixing device from lifting off the base plate 8, in this embodiment that purpose is served by the bridge-like connection 34 and a projecting pin portion 39 which can be fixed to the part 8a of the base plate 8 and which is displaceably guided in a slot-shaped opening 38 in the fixing device 5. The same purpose is served by a pin portion 37 which is fixed to the part 8b and which is displaceably mounted in the slot 36.

1. A mounting device for fixing a furniture hinge including a base plate to be fixed to a furniture part, in particular a side wall of a furniture carcass, and a fixing device for preferably releasably fixing the hinge to the mounting device, wherein the fixing device is mounted moveably on the base plate, wherein the mounting device has a connecting element which is mounted moveably to the base plate by way of at least one hinge lever and which can be fixed to a part of the hinge, that is moveable in the opening and the closing movement of the hinge, wherein the fixing device is moveable relative to the base plate by way of the hinge lever.

2. A mounting device as set forth in claim 1 wherein the connecting element can be fixed to an outside, preferably to the top side, of the moveable part of the hinge.

3. A mounting device as set forth in claim 1, wherein the fixing device is moveable relative to the base plate by way of the hinge lever with a linear component.

4. A mounting device as set forth in wherein the hinge can be clipped on to the fixing device.

5. A mounting device as set forth in claim 1, wherein the connecting element can be clipped to the moveable part of the hinge.

6. A mounting device as set forth in claim 1, wherein the connecting element has a plate-shaped or profile-shaped part which in the mounted condition of the hinge bears in areal relationship against the moveable part of the hinge or at least partially embraces same.

7. A mounting device as set forth in claim 1, wherein the connecting element is in the form of a two-part lever (18a, 18b).

8. A mounting device as set forth in claim 1, wherein the fixing device is hingedly connected to the hinge lever.

9. A mounting device as set forth in claim 1, wherein the fixing device is mounted moveably to the base plate by way of at least one further hinge lever.

10. A mounting device as set forth in claim 1, wherein arranged on the base plate (8) is at least one mounting lug (21a, 21b) to which the hinge lever (7a, 7b) is rotatably mounted.

11. A mounting device as set forth in claim 1, wherein the at least one hinge lever is mounted rotatably to the base plate by way of a gear or a gear segment.

12. A mounting device as set forth in claim 11, wherein arranged on the base plate is at least one toothed bar with which the gear or the gear segment meshes.

13. A mounting device as set forth in claim 1, wherein a guide device is arranged on the base plate for guiding the movement of the fixing device relative to the base plate.

14. A mounting device as set forth in claim 1, wherein the fixing device is of a substantially plate-shaped configuration or has a receiving plate.

15. A mounting device as set forth in claim 1, wherein the hinge lever and the connecting element are of dimensions adapted for fixing the hinge element to the hinge arm or to an intermediate portion which is mounted moveably to the hinge arm and which is coupled to the hinge arm by way of at least two levers.

16. An arrangement including a hinge, in particular a wide-angle hinge, and a mounting device as set forth in claim 1.

17. An arrangement as set forth in claim 16 wherein the hinge has a hinge arm fixable to the fixing device.

18. An arrangement as set forth in claim 16 wherein the hinge has a hinge arm and an intermediate portion which is mounted moveably to the hinge arm and which is preferably coupled to the hinge arm by way of at least two levers and wherein the connecting element is fixable to the intermediate portion

19. An article of furniture comprising a furniture carcass and a furniture door mounted pivotably to the furniture carcass, characterised by a mounting device mounted to the furniture carcass, as set forth in claim 1, and a hinge fixable to the mounting device, preferably a wide-angle hinge, for opening and closing of the furniture door.
